(19) United States
(12) Patent Application Publication
(10) Pub. No.: US 2012/0107215 A1
(43) Pub. Date: May 3, 2012

(54) METHOD OF REMOVING AND RECOVERING SILICA USING MODIFIED ION EXCHANGE MATERIALS

(75) Inventors: Michael C. Gottlieb, Cherry Hill, NJ (US); Peter S. Meyers, Marlton, NJ (US)

(73) Assignee: RESINTECH, INC., West Berlin, NJ (US)

(21) Appl. No.: 13/009,321

(22) Filed: Jan. 19, 2011

Related U.S. Application Data
(62) Division of application No. 12/412,073, filed on Mar. 26, 2009, now abandoned.

(51) Int. Cl. C01B 33/12; C01B 33/113

(52) U.S. Cl. 423/339; 423/325

(57) ABSTRACT

A method of preferentially removing or recovering silica from a source, including aqueous sources such as ground and potable water, which utilizes a modified ion exchange material that holds or captures the silica by ion exchange with a metal contained in the exchange material whereby the method includes the steps of: providing an ion exchange material; immobilizing a metal complex to form at least a portion of a metal containing substance inside the ionic exchange material; and contacting the source with at least a portion of the metal containing ionic exchange material.

### FIELD OF THE INVENTION

The present invention relates, generally, to a method of removing and recovering silica from various sources, including ground and potable water sources, using modified ion exchange materials.

### BACKGROUND OF THE INVENTION

The chemical compound silicon dioxide (SiO₂), also known as silica, is an oxide form of silicon (Si) and has been known for its inertness and hardness since ancient times. Silica is most commonly found in nature as sand or quartz and has a molecular weight of 60.1.

The soluble form of silica is monomeric (containing only one silicon atom) and generally formulated as Si(OH)₄. This is often called monosilicic acid or orthosilicic acid. Si(OH)₄ is essentially non-ionic in neutral and weakly acidic solutions and is not transported by electric current unless ionized in alkaline solution. It also cannot be easily removed from water by salinification of the water nor can it be extracted from water by neutral organic solvents. Further, Si(OH)₄ remains in the monomeric state in water at 25° C. for long periods of time if its concentration is less than about 2 μM.

The question sometimes arises as to whether the term “soluble silica” should include lower molecular weight polymers such as tetramers or decamers, which are classified as “oligomers.” “Soluble” materials, unlike colloidal materials, are generally recognized as those materials that pass through a dialysis membrane. However, today, membranes can be made with pores sufficiently small to separate dextrose from sucrose. Nevertheless, despite not being colloidal yet unable to pass through a dialysis membrane, sucrose is generally considered to be “soluble.” It is therefore appropriate to provide the following terminology and definitions to apply throughout this specification which are consistent with the terminology and definitions used by R. K. Iler, “The Chemistry of Silica,” Wiley (ISBN 0-471-02404-X), New York, 1979.

Soluble silica is defined by Iler as including polymers with molecular weights up to about 100,000 (e.g., SiO₂), whether consisting of highly hydrated “active” silica or dense spherical particles less than about 50 Å in diameter. Soluble silica is mainly derived from the weathering of minerals which, in some cases, results in amorphous silica residues that then dissolve. River water generally ranges from 5 to 35 ppm SiO₂ and, by the time it reaches the oceans, silica may range from 5 to 15 ppm. In addition to the silica carried into the oceans by fresh water, additional soluble silica comes from the suspended colloidal clays and related minerals. By comparison, colloidal silica is considered to be more highly polymerized species or particles larger than about 50 Å, although sometimes colloidal silica can be as small as 10-20 Å. When used generally herein, “silica” refers broadly to either soluble silica or colloidal silica.

Silica has been reported by Iler as constantly dissolving and precipitating over a large part of the earth's surface. These sedimentary cycles of silica are generally understood. The dissociation constant for the first silica acid is 9.79×10⁻¹⁰. The dissociation constants for the dissociation reactions that follow are shown below:

1^{st} H⁺ dissociation: H₄SiO₄⁻→H⁺+H₃SiO₄⁻ (K₁=9.79×10⁻¹⁰ or 2×10⁻¹⁰);

2^{nd} H⁺ dissociation: H₃SiO₄⁻→H⁺+H₂SiO₄⁻² (K₂=2×10⁻¹²);

3^{rd} H⁺ dissociation: H₂SiO₄⁻→+HSiO₃⁻³ (K₃=2×10⁻¹²); and

4^{th} H⁺ dissociation: HSiO₃⁻→H⁺+SiO₃⁻⁴ (K₄=2×10⁻¹²).

It is mentioned that the CRC Handbook lists K₃=1×10⁻¹² and K₄=1×10⁻¹².

Quartz, which consists of a lattice of silica tetrahedra, is said to be the most abundant mineral in the earth's crust. Importantly, below pH 9, quartz's solubility is independent of pH and the dissolution reaction is SiO₂ (quartz)+2H₂O(1) [symbol] H₄SiO₄ (K=2×10⁻³, at 25° C.). This corresponds to a solubility of the monomeric form of silica of 120 mg/L; however, generally SiO₂ is found at levels of 1-100 mg/L (ppm). This is relevant because various water sources, including potable water sources, often contain quartz and because many different industrial applications generally have a pH in the range of 4 to 9. At this pH range, silica in water or aqueous solutions is predominantly un-ionized and therefore not hindered by what is known as the Donnan membrane effect or Donnan barrier. Thus, being non-ionic, it is able to pass unrestricted into the gel phase of either a cationic or anionic exchange resin. This is shown in FIG. 1 where the activity of dissolved silica is plotted at various pH values.

Silica concentrations in, e.g., boiler plant make-up feed water and potable waters are generally reported as the un-hydrated form as SiO₂. Silica vaporizes with steam and therefore is important in boiler systems as well as other systems in which steam is generated and/or condensed. When steam condenses, silica often deposits undesirably on various equipment parts including, e.g., on turbine blades of engines and generators.

Silica is equally of concern in many processes that separate pure water from salt, such as reverse osmosis, electrodialysis and distillation systems as well as those using evaporative cooling. All these processes share the concern that silica concentrations will increase as water is removed. Precipitation of silica (by itself or along with other limited solubility salts), results in undesirable effects on the process or component materials.

Silica levels in engineering systems are controlled by various means depending on such factors as the nature of the system or process, the equipment design and/or the system operating pressure. For example, silica levels in lower pressure boiler systems are often controlled by relatively simple periodic boiler blowdowns. However, as operating and design pressures of boilers increase, the acceptable level of silica in boiler feed water typically decreases. As a result, in moderate and high pressure boilers, it is often desirable, and even necessary, to reduce silica levels of the influent boiler feed water so that the boiler can be operated with lower blowdown rates.

A desilicizer is a vessel containing a strong base anion exchange resin that is operated in the hydroxide form such that the resin is typically regenerated with sodium hydroxide. In order to operate effectively, desilicizers often have a softening step prior to the desilicizer step; otherwise multivalent metal ions, such as calcium, magnesium, iron and zinc, will likely precipitate in the ion exchange material. This is because exchange reactions in the desilicizer result in an aqueous process stream containing, not only metal ions, but also a high concentration of hydroxide ions. As a result, desilicizer effluents tend to have a high pH that causes the metal ions to precipitate if not first removed by a softener. Accordingly, it is common for a desilicizer to be placed in series with a softener so that the process stream passes through the softener and then the desilicizer before entering, e.g., a boiler. Also, because hydroxide ions are considered undesirable substances in boiler influents, it is often necessary to feed acid into the process to neutralize the desilicizer effluent prior to feeding it to the boiler. This adds another level of complexity and cost.

Desilicizers are considered to be limited and inefficient. Regenerating the resin with sodium hydroxide is expensive. Also, silica has a relatively low affinity for strong base resins compared to ions such as chloride, sulfate, bicarbonate and carbonate that are usually present in water at much higher concentrations compared to silica. Because desilicizers typically remove ions from an aqueous source non-preferentially, many different ions compete for the hydroxide ion exchange sites on the resin. Not surprisingly, many engineering systems in operation today operate without desilicizers because of these and other limitations and inherent inefficiencies. Instead, many systems operate with more expensive deionizers (also known as demineralizers) in order to achieve greater silica removal.

As boiler pressures continue to rise, the allowable level of silica in boiler feed water continues to decrease. This requires more sophisticated equipment and more stringent controls to achieve acceptable silica levels. This is often accomplished by using deionization/demineralization. A similar approach involves the use of a two bed demineralizer in which a cation resin is located in a first portion of the demineralizer that is operated in the hydrogen form and regenerated with acid instead of salt as is the case with a softener. This is followed by an anion portion of the demineralizer which is operated in a similar manner as the desilicizer described above. As a result of operating with both cation and anion resins, the two bed demineralizer effluent is essentially neutral and little if any pH control is necessary. The effluent is also substantially free of all ions, including silica. Thus, desilicizers are used with much less frequency compared to demineralizers as the benefits associated with complete deionization typically outweigh their slightly higher operating costs.

There remains a need for a cost effective, highly selective method for removing and/or recovering silica from various sources, including aqueous sources such as ground, potable and process waters including, but limited to, high purity waters containing trace levels of silica that overcome some of the drawbacks of existing technology that requires conditioning steps or the conversion of ions in the source to another form. This is accomplished by the methods and modified ion exchange materials described herein.

### BRIEF SUMMARY OF THE INVENTION

The present invention relates generally to a method that incorporates metal salts usually insoluble oxides and/or hydroxides throughout ion exchange materials. More specifically, the method of the present invention for removing and recovering silica includes the steps of loading or exchanging a metal onto an ion exchange material, immobilizing the metal throughout the exchange material to form a modified ion exchange material, and contacting the source with the modified ion exchange material. By this process, as described in further detail below, the present invention is directed to the highly selective removal of silica from various sources including, in particular, aqueous sources.

Using the method of the present invention and the modified materials described herein, silica—in the form of un-ionized monomeric, monovalent, and polyvalent silica—is effectively removed from ground and potable water. Preferably, the modified ion exchange materials are strongly basic or weakly basic or intermediate basic anion exchange materials with at least one metal inside the materials such that the method described and claimed herein effectively and efficiently removes silica from various sources. However, the modified ion exchange materials can also be cation exchange materials, either weakly acidic or strongly acidic, such that a metal complex group is immobilized inside the materials. Regardless of whether the starting exchange material is anionic or cationic, the method of the present invention is still capable of removing un-ionized or non-ionic silica from an aqueous source as the silica freely interacts with the modified exchange materials without interference or limitation due to ionic effects, including those caused by the so-called Donnan membrane. However, in addition to removing and recovering non-ionic silica from a source, the method of the present invention is also capable of removing and recovering ionic (monovalent and polyvalent) silica from various sources.

### BRIEF DESCRIPTION OF DRAWING FIGURES

The invention will be described in conjunction with the following drawing figures wherein:

FIG. 1 is a chart showing the activity of dissolved silica species at various pH values;

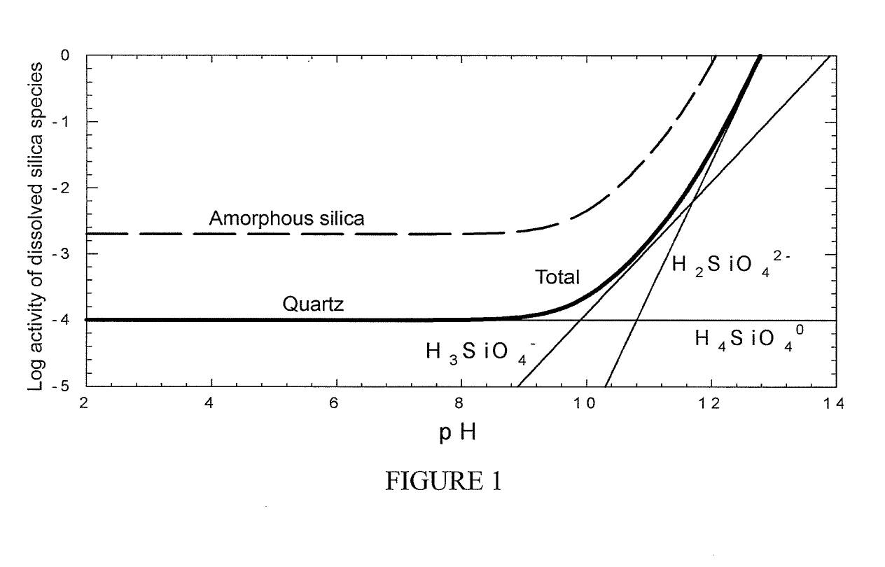

FIG. 2 is a chart showing how silica ionization varies with pH;

FIG. 3 is a chart showing the removal of silica with hydroxide and chloride forms of SBG1 ion exchange materials;

FIG. 4 is a chart showing the removal of silica with a borate form of SBG1 ion exchange material;

FIG. 5 is a chart showing the removal of silica with an iron impregnated CG8 cation exchange material;

FIG. 6 is a chart showing the removal of silica with ASM-10 HP OH and SBG1 OH cation exchange materials;

FIG. 7 is a chart showing the removal of silica with SBG1 Cl and ASM-10 Cl forms of cation exchange materials;

FIG. 8 is a chart showing removal of silica with a modified anion exchange material that has been regenerated;

FIG. 9 is a chart showing removal of silica with a modified anion exchange material that has been regenerated;

FIG. 10 is a chart showing the effect of contact time and temperature on silica removal with an ion exchange material;

FIG. 11 is a chart showing the elution of silica from exhausted ASM-10 HP resin during regeneration with 4% NaOH at room temperature.

### DETAILED DESCRIPTION OF THE INVENTION

There is a need for an improved method or process for removing and/or recovering silica from various sources including those sources that cover a wide range of pH values. The present invention relates primarily to a method or process that uses ion exchange materials (e.g., resin) in which a complexing group containing a metal is, not only attached to but is also located, precipitated or immobilized inside the exchange material. The method of the present invention for removing and recovering silica includes the steps of loading or exchanging a metal onto an ion exchange material, immobilizing the metal throughout the exchange material to form a modified ion exchange material, and contacting a source containing silica with the modified ion exchange material. The method of the present invention is not intended to be limited to a particular type of ion exchange material and, instead, includes all types of ion exchange materials including those with mixed functionality, whether selective or non selective, whether cation or anion or mixtures thereof and regardless of degree of ionization of the functional groups. Also, the modified exchange materials described herein are effective to some degree in any liquid that can solvate it including, for example, alcohols, glycols and sugar solutions.

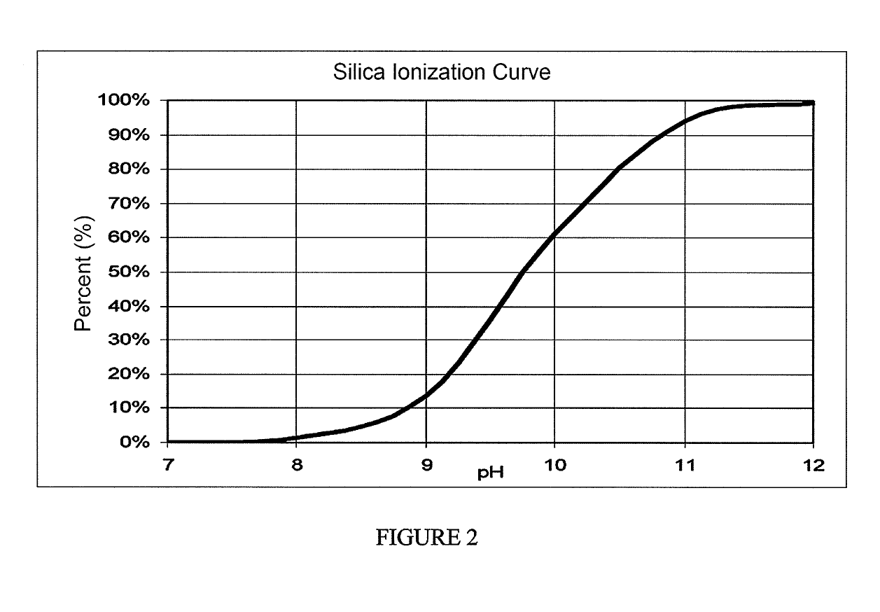

Silica in water is a very weakly ionized acid. At neutral to slightly alkaline pH, silica is mostly present as un-dissociated silicic acid. Only a small fraction of silica is present as the silicate anion at the pH typically encountered in natural waters. FIG. 2 shows how silica ionization varies with pH. Silica chemistry is quite complex and there remains some dispute as to the various silica species present in water. A generally accepted formula for silicic acid is H₄SiO₄. However, the water treatment industry uses the term silica (SiO₂) interchangeably with silicic acid. Thus, while the two terms are generally considered to be synonymous, SiO₂ is typically the silica form found in dry deposits while H₄SiO₄ is the form found when silica is surrounded by water molecules (2H₂O+SiO₂═H₄SiO₄). Depending on pH, a portion of silicic acid present in an aqueous solution ionizes to form silicate ions (H₃SiO₃⁻). For purposes herein the terms silica and silicic acid are considered to be synonymous.

Silica is known to combine with various metal oxides and hydroxides to form relatively insoluble salts. For example, silica (unionized) and silicate (H₃SiO₃⁻) will react with ferric hydroxide Fe(OH)₃ to form ferric silicate. It will be appreciated that other metals and metal oxides will also form insoluble salts when combined with silica in water. Other metal oxyanions, such as PO4, As₂O₄, and SeO₄ to name only a few, will also be competitively absorbed. Arsenic, for example, is strongly attracted to and removed by metal oxides and hydroxides. Hydroxide ions interfere with silica absorption by acting as competing ions but also enhance its removal by ionizing the silica enabling it to be more readily removed by reaction with the precipitated metal.

The modified ion exchange materials made by the method described herein offer unique and surprising opportunities for the selective removal of silica from various sources. The degree to which silica is ionized in an aqueous environment depends on the pH of the environment. pH is defined as the negative value of the logarithm of the hydrogen ion concentration in gram equivalent weights per liter. For example, truly neutral water is neither acidic nor alkaline, and the hydrogen ion concentration is 1×10⁻⁷ gram equivalents per liter. Since hydrogen is a monovalent ion, the concentration is also 1×10⁻⁷ moles/liter. The log of the concentration is −7. The negative of the log is 7. As presented above, the dissociation constant for the first hydrogen ion of H₄SiO₄⁻ is 9.79×10⁻¹⁰. At pH 7, the degree of silica ionization is approximately 0.016% whereas, at pH 8, it is 1.6%. At a pH of 9-10, silica becomes 50% ionized and is 94% ionized at pH 11. This is particularly important in the parlance of “water treatment” where silica is considered to be both a non-ionic and an anionic substance. When the pH is relatively low, silica is non-ionic and when the pH is relatively high, silica becomes ionized. In fact, silica it almost always present in both non-ionic and ionized forms; however, the ratio of un-ionized to ionized silica increases with decreasing pH.

It is known that silica can be removed by the hydroxide form of strongly basic anion exchange resins. It is also known that the mechanism for such removal is that hydroxide ions are exchanged for anions in, e.g., water which increases the pH causing silica to become ionized and then exchanged. The resin can only remove silica so long as it can create a pH that enables the silica to be ionized. However, this process has its drawbacks including the fact that the amount of water that can be treated is limited by the hydroxide capacity of the resin. It is also inefficient due to the non-selective exchange of hydroxide ions for all the anions present. In other words, all other anions are removed in the process of removing silica. Once the resin becomes exhausted of hydroxide ions the pH in the resin is reduced. As a result, the silica becomes non-ionic and leaves the resin. Thus, the resin is not selective for silica and silica dumping can occur even before the hydroxide capacity is used up by the competition of the other ions in the water. Strong base resins can be operated in many forms some of which will increase the pH and likewise facilitate silica removal by the resin. But in all cases, once the pH adjusting effect of the exchangeable ion is exhausted, the silica is dumped.

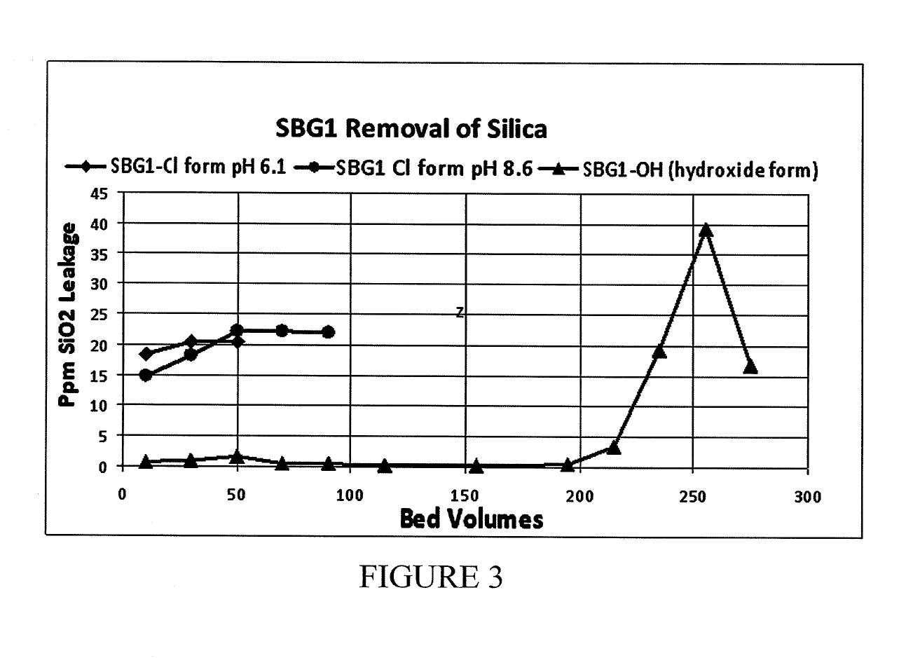

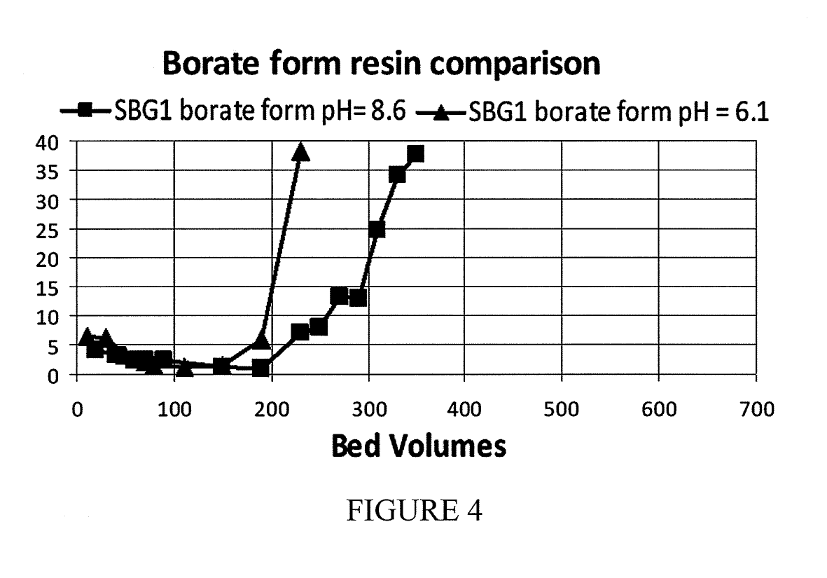

FIGS. 3 and 4 clearly show this for the hydroxide and borate forms of ResinTech SBG1 ion exchange resin. Also shown in FIG. 3 is silica removal by the chloride form of this resin. The effluent pH during the exchange is typically between pH 5 and 6 due to removal of bicarbonate ions and the presence of CO₂ in the water which passes through the resin as a primarily non-ionic substance but hydrolyses to form small amounts of carbonic acid in the effluent. As a result, only the ionic portion of silica can be removed which is a relatively small fraction. The remaining silica then equilibrates to replace the missing ionized portion by additional dissociation. This requires many removal and equilibrium cycles, and the rate of exchange under these conditions is quite slow. Strong base anion resins prefer chloride ions strongly over silicate ions. The operating available capacity of a chloride form anion resin for silica under these conditions is not significant. The borate form of a strong base anion resin is more successful at removing silica than the chloride form because the relative affinity for borate ions is lower than for silicate ions. It follows that the borate form of ion exchange resins, including the modified exchange resins described herein, can be used effectively in treating reactor water in the nuclear power industry. However, borate ions are not only replaced by silicate ions but by almost all other ions as well. This exchange often results in the undesirable addition of borate ions to the effluent water. It should be appreciated that the ionic form of a resin, or its resultant hybrid has an effect on the resins ion exchange capacity for silicate ions and that converting the hybrid to any particular ionic form can be practiced within the field of this invention.

Also, as shown in FIG. 3, the exchange of silica is poor compared to other ions and higher leakage occurs quickly for the chloride form of the resin. Many water treatment professionals would be surprised to learn that even small amounts of silica can removed by non-hydroxide form resins and even more surprised to learn that removal can occur with neutral salt forms of resins, such as chloride resin forms. The more alkaline the salt, the greater the ability of the resin to remove silica. Salts of weak acids also raise the pH after exchange and generally enhance silica removal. The hydroxide ion is considered to be the most effective ion in raising pH such that, when the resin exchanges hydroxides, silica leakage is at its lowest. However, both the bicarbonate and carbonate forms of a strong base anion resin may raise the pH to some degree and result in some degree of silica removal.

Weak base versions work like the strong base but at an alkaline pH they do not react as ion exchanges leaving the metal to remove the silica. Unlike the cation version, ionized silica is free to enter the gel phase without hindrance. Regeneration of the weak base versions is as easy as for the strong base versions because the hydroxide ions can enter the gel phase. Thus, a weak acid cation resin could work as a softener and silica remover, e.g., in applications where high total dissolved solids (TDS) in water are softened. Weak acid resins are used in the sodium ion form as the final stage of softening as polishers and could also reduce silica for boiler feed applications. Weak base resins and weak acid resins are available in gel and macroporous forms. ResinTech CG8 is an example of a strongly acidic or “strong acid” cation exchange resin. Examples of weak acid cation exchange resins are R&H IRC84, R&H IRC50, Ionac CC, ResinTech WACG and ResinTec WACMP.

Ion exchange materials (e.g., resins) typically have fixed ionic charges dispersed throughout a polymer material and mobile counter ions that can be exchanged by altering concentration and quantity of charges. For example, anion resins have fixed or immobile positive charges that are balanced by mobile negatively charged ions whereas cation resins have fixed/immobile negative charges balanced by mobile positively charged ions. It has been known that “[w]hen two coexistent phases are subject to the restriction that one or several of the ionic constituents present in them cannot pass from one phase to another, a particular equilibrium, known as a Donnan Equilibrium, is established. Usually the restriction is caused by a membrane which is permeable to solvent and to small ions but is impermeable to large ions; therefore, these equilibria are described as Donnan membrane equilibria. The presence of a membrane is not essential; however, in a gel or in an ion exchanger where there are structurally bound ions, the equilibria also are of the Donnan type. The important aspects of the Donnan equilibrium with ion exchangers are that an unequal distribution of ions, an osmotic pressure difference, and a potential difference exist between the gel and external phases.” G. E. Boyd and K. Bunzl, “The Donnan Equilibrium in Cross-Linked Polystyrene Cation and Anion Exchangers,” J. American Chemical Society, 1 89:8, Apr. 12, 1967.

As a result, the fixed charges within the polymer material act, in a sense, as a barrier to limit the entry of ions that have the same charge (negative or positive). This Donnan exclusion barrier is not absolute but rather is proportional to the concentration difference between the ions in the polymer phase and those in the liquid phase. Also, the Donnan exclusion barrier is greater at lower ionic concentrations. However, because the fraction of ions that will pass through the Donnan exclusion barrier depends on relative ion concentrations, it is possible to manipulate the ion concentration outside, e.g., a resin bead such that anions will penetrate a cation bead and cations will penetrate an anion bead.

Non-ionized silicic acid (silica) is not affected by the Donnan exclusion barrier or membrane effects and thus can penetrate either cation or anion exchange materials such as resin beads. The adsorption of non-ionized substances, such as silica or other non-ionized substances such as sugar, is a recognized property of ion exchange resins; however, in most cases, the amount of adsorption is too small to be of any practical value unless the concentrations are high as, for example, in commercial syrup production where concentrations are measured in percent. That is because the adsorption is a function of the solubility of the non-ionized substance in the water or liquid portion of the resin. In the case of un-ionized monomeric silica, which has a maximum solubility of 100 to 120 ppm, this is typically several hundred times lower in magnitude compared to the ion exchange capacity of the modified exchange material or the functional groups of the parent resin.

Ion exchange materials are used to remove unwanted ions from aqueous sources, especially water, by exchanging them for more desirable counter ions from the mobile charges within the material. For example, strongly basic anion resins have the ability to adsorb weakly ionized acids such as silica and then exchange for the ionized species. A strong base anion resin in a neutral salt form, such as ResinTech's SBG1-Cl (chloride form) resin, will exchange various small amounts of ionized silica depending on pH. The exchange improves as pH increases because silicic acid is more completely ionized at higher pH. When a strong base anion resin is in the hydroxide form (and the operating pH is very high) the resin is capable of removing large amounts of silica as the silicate anion. This, however, makes silica susceptible to chromatographic peaking, commonly known as “dumping,” if the exchange is continued past the point where the hydroxide exchange sites are depleted.

The method of this invention can be operated at a variety of pHs, including at or near neutral pH, and does not require an ionic preconditioning step, including the use of a softener as described above. The method of this invention also does not require significant pH adjustment in order to effectively remove silica from various sources yet it is capable of removing and recovering silica preferentially compared to other ions or contaminants in those sources. Also, while the modified ion exchange material described in the present invention will need to be regenerated from time to time, the present invention's capacity for silica is several times greater than known ion exchange processes and therefore more efficient than these processes. These, as well as other, aspects of the present invention make it less expensive to operate than other processes for removing and recovering silica. Thus, the present invention provides a cost effective process for using modified ionic exchange materials having a metal inside the materials which is capable of removing and/or recovering silica in a very wide range of operating conditions since the metal inside the exchange materials is not easily removed from the modified materials.

Without intending to be limited to the following description, the present invention is directed to and claims a process of removing and recovering silica from a source by using an ion exchange material, preferably a strongly basic anion exchange resin, most preferably a strongly basic gel type anion exchange resin, that contains at least one metal inside the exchange material yet the exchange material remains available to take place in chemical reactions, redox reactions and chemical sorption reactions. That is, the ion exchange material retains its original ion exchange characteristics and, therefore, the exchange material may or may not take part in the reaction process involving, for example, the removal of a contaminant by the metal itself.

For example, an ion exchange material made with tri-ethylamine functional groups has reduced selectivity for certain ions or classes of ions. This type of exchange material has a reduced affinity for multivalent ions and is useful in removing nitrate from potable water. In such applications, sulfate is potentially a major interfering substance. An ion exchange material with a reduced affinity for sulfate has benefits over materials which prefer sulfate over nitrates. Tri-ethylamine based resins are often referred to as being “nitrate selective” because of their ability to resist sulfate interferences. When a resin, based on tri-ethylamine functionality, is treated by the method of the present invention, it continues to function as a nitrate selective resin with an additional functional ability of selectively removing silica. In other words, the resin becomes a dual use resin, nitrate selective and silica selective. In a similar manner, other special purpose ion exchange resins can have an added functionality of becoming silica selective by the process described herein. Similarly, cation exchange resins can also have added functionality of becoming silica selective by the process described herein.

As used herein, the term “anion exchange material” means anion exchange materials, such as resins, granules, beads, and grains. These can be gel types or macroporous types, most preferably, gel types having at least one metal wherein at least a portion of the metal is inside the materials as taught herein. Such anion exchange materials may include, but are not limited to, anion exchange resins, membranes and structures. The anion exchange material with which one starts, may be any particular water-insoluble polymeric material which contains strongly basic amine groups attached to the polymeric material including those described in more detail below. Such anion exchange materials are known to those of ordinary skill in the art and selection of a particular anion exchange material or structure is considered within the skill of those knowledgeable in this field.

The anion exchange materials of the present invention are preferably anion exchange resins which are formed by the chloromethylation and amination of an organic polymer, such as polystyrene. The underlying polymer may contain ring-based materials, such as benzene rings, or non-ring based materials, such as, but not limited to, acrylic acid or methacrylic acid. Polymerization of an aromatic amine and an aldehyde or by polymerization of a polyamine, a phenol and an aldehyde is also possible. Such resins have a large number of electrically charged functional groups disbursed throughout their structure. In general, the extent of polymerization or condensation in the resins is carefully controlled so that a limited amount of cross-linking occurs to render the resins insoluble in water or any other polar solvent with which they are to be employed but leaving them capable of absorbing water or other solvents so as to swell therein. The presence of water or other polar solvents absorbed in the resins causes or enables ionic mobility throughout the resin bead so that the mobile ions can interact with the functional groups and can be exchanged for other anions from the resin. For example, a resin in the hydroxide form can exchange its hydroxide ions for an equivalent amount of chloride or sulfate ions.

The anion exchange materials suitable for preparing the modified materials of the present invention are organic porous materials with ionic charges and anion exchange capacity. Preferably, the anion exchange materials are polymer-based and, as described above, sometimes referred to as anion exchange resins. Polymer-based anion exchange materials are commercially available or can be readily prepared from materials that are commercially available and cover a broad spectrum of different anion exchange materials with varying exchange capacity, porosity, pore size and particle size. Preferably, the materials are either macroporous or gel type materials.

All anion exchange resins contain a gel phase, which is the name commonly used to describe the interior of an ionically charged polymer. The polymer itself is sufficiently porous on a molecular scale to allow ions to travel freely through out the particle. Macroporous resins also have physical porosity. Materials, especially resins, with physical porosity are typically referred to as “macroporous” or “macroreticular.” Materials without physical porosity are referred to “gel types.” The gel-phase of organic anion exchange materials are particularly preferred in the practice of the present invention which applies to both macroporous and gel type resins. By “macroreticular,” as the term is commonly used in the art, generally means that the pores, voids, or reticules are substantially within the range of about 200 Å to about 2,000 Å. Macroreticular resins are also referred to as macroporous resins.

Anion exchange resins are characterized as either strong base or weak base anion exchange resins depending on the active ion exchange sites of the resin. The resin matrix of weak base anion-exchange resins contain chemically bonded thereto a basic, nonionic functional group. The functional groups include primary, secondary, or tertiary amine groups. These may be aliphatic, aromatic, heterocyclic or cycloalkane amine groups. They may also be diamine, triamine, or alkanolamine groups. The amines, for example, can include alpha, alpha-dipyridyl, guanidine, and dicyanodiamidine groups. Other nitrogen-containing basic, non-ionic functional groups include nitrite, cyanate, isocyanate, thiocyanate, isothiocyanate, and isocyanide groups. Pyridine groups may also be employed.

Strong base anion exchange resins consist of polymers having mobile anions, such as hydroxide and the like, associated for example with covalently bonded quaternary ammonium, phosphonium or arsonium functional groups or tertiary sulfonium functional groups. These functional groups are known as active sites and are distributed through out the volume of the resin. Strong base anion-exchange resins have the capacity to undergo ion exchange independent of the pH of the medium by virtue of their intrinsic ionic character. Strong base anion exchange resins in the hydroxide form are particularly preferred in the practice of the present invention.

Weakly basic resins are similar in some respects to strongly basic resins. However, where weakly basic resins are typically primary, secondary or tertiary amine polymers, strongly basic resins are usually characterized as quaternary amine polymers. Weakly basic resins have limited ability to raise the operating pH and tend to operate best at pH less then 7. Weakly basic resins can be loaded with precipitated metal in the same manner as strongly basic resins and remove both ionized and un-ionized silica. For example, in naturally high pH waters (e.g., the Great Lakes where the pH is approximately 7.8) a weakly basic parent resin with precipitated metal will remove both ionized and un-ionized forms of silica.

Weakly basic resins are usually, but not always, operated at acidic pH. They can be operated at the same pH as the cation and strongly basic anion parent resin products for silica reduction and offer the advantage of a single alkaline regenerant with little or no need for post-regenerant neutralization. Thus, weakly basic resins can remove silica without raising the pH of water. Some examples of weakly basic resins are: R&H IRA 68, R&H IRA 93, and Duolite A30B, lonac A305, Duolite A340, ResinTech WBACR, ResinTech WBMP, ResinTech WBG30, and Duolite A6.

Fant reported selectivity coefficients for the hydroxide form of a Type I strong base resin to be approximately of 0.2 and 0.14 for HSiO₃⁻ and SiO₃⁻², respectively, for the dissociation and exchange of silicic acid. P. Fant, Ionic Character of Silica Present In Ion Exchange Resins. This means that ionized silica can be removed by the salt form of an ordinary strong base resin. This also means that the ions can adhere onto the resin as an additional pathway into the gel phase of the resin and therefore be preferentially adsorbed by the metal hydroxide. In the case of the modified anion exchange material of the present invention, the ionized forms of silica are adsorbed directly onto/into the fixed metal of the exchange material.

Examples of suitable strong base anion exchange resins are known in the art and are disclosed in Samuelson, Ion Exchange Separations In Analytical Chemistry, John Wiley & Sons, New York, 1963, Ch. 2, incorporated herein by reference. Hence, preferred anion exchange resins are those resins having quaternary ammine exchange groups chemically bound thereto, for example, styrene-divinyl benzene copolymers substituted with tetramethylammoniumchloride. Also, preferred anion exchange resins include crosslinked polystyrene substituted with quaternary ammine chloride such as the ion exchange resins sold under the trade names AMBERLITE IRA-400 by Rohm and Haas Company and DOW SBR by Dow Chemical Company or ResinTech SBG1.

Examples of anion exchange materials suitable for the present invention also include: strong base cross-linked Type I anion exchangers; weak base cross-linked anion exchangers; strong base cross-linked Type II anion exchangers; strong base/weak base anion exchangers; strong base perfluoro aminated anion exchangers; and naturally occurring anion exchangers such as certain clays. The anion exchange materials can be a strongly basic resin with acrylic or styrenic polymer having a variety of amine exchange groups including, but not limited to, trimethylamine, triethylamine, tributylamine, dimethalethanolamine, dimethylamine and trihexylamine.

Strongly basic anion-exchange resins can also be quaternary ammonium resin containing —CH₂N(CH₃)ₙ+X— groups, that is the type known as Type I resin. Type II resins, which contain —CH₂N[(CH₃)₂(CH₂CCH₂OH)]+X— groups, may also be used effectively. The anion exchange material is said to be in the chloride form when X— is the chloride ion (Cl—). However, after regeneration according to the method of the present invention, X— represents hydroxyl ion OH—, and the anion material is said to be in the hydroxide form. The anion active resins may be activated or regenerated by passing a dilute solution, for example, 0.1%-20% of sodium carbonate, caustic soda, potassium carbonate, potassium hydroxide, organic bases or neutral salts and the like through the bed and subsequently washing with water.

Examples of suitable resins are gel-type anion exchange resins which contain primary, secondary, tertiary amine and quaternary ammonium groups. Such resins include Amberlite IRA-400, Amberlite IRA-402, Amberlite IRA-900, Dowex I, Dowex 21K, Ionac A540, Ionac A-260 and Amberlite IRA-68, IRA-93, IRA-96, Dowex SBR, Dowex SAR, Dowex SBR-P, Dowex MSA-1, Dowex MWA, ResinTech SBG1, ResinTech SBG1-P, ResinTech SBG2, ResinTech SBACR, ResinTech SBMP1, ResinTech WBMP, ResinTech WBACR, ResinTech WBG30 and ResinTech SIR-22P.

Macroporous resins can also be used effectively in preparing the modified anion or cation exchange materials of the present invention. Some of the macroporous resins which can be used effectively are those listed in Ullmann's Encyclopedia under the heading “Strong Base anion resins—macroporous types.”

Other commercially available anion exchange resins which are useful in the present invention include: the Purolite anion exchange resins A-600, A-400, A-300, A-300E, A-400, A-850, and A-87, Rohm & Haas resins IRA-400, IRA-402, IRA-904 and IRA-93; and Dow resins SBR, SAR, Dowex 66 and Dowex II, Ionaci ASB-1, Duolite A-109 and the like.

As referred to in U.S. Pat. No. 4,366,261, still other effective commercial anion resins are discussed in the Kirk-Othmer Encyclopedia of Chemical Technology, Vol II, pages 871-899 on the subject of “Ion Exchange.” Yet another helpful reference is a book titled “Ion Exchange” by Frederich Helfferich published by McGraw-Hill, 1962. Additionally, detailed information about pore sizes of “gel-type,” “microreticular,” and “macroreticular” ion exchange resins may be found in Ion Exchange in The Process Industries published in 1970 by The Society of Chemical Industry, 14 Belgrave Square, London, S.W.I., England.

Any other anion active resin may be used in making the modified anion exchange materials of the present invention including but not limited to: m-phenylene diamine-formaldehyde resins, polyamine-formaldehyde resins, alkyl and aryl substituted guanidine-formaldehyde resins, alkyl and aryl substituted biguanide-, and guanyl urea-formaldehyde resins, for example, corresponding condensation products of other aldehydes, for example, acetaldehyde, crotonaldehyde, benzaldehyde, furfural or mixtures of aldehydes may also be employed if desired. The resins such as those prepared from the guanidine, guanyl urea, biguanide, the polyamines, and other materials which do not form substantially insoluble condensation products with formaldehyde for most practical purposes are preferably insolubilized with suitable materials, etc., urea, aminotriazines, especially melamine, the guanamines which react with formaldehyde to produce insoluble products, etc. Furthermore, mixtures of the anion active materials as well as mixtures of the insolubilized materials may be used.

Usually it is convenient to employ the salts of the bases but the free bases may also be used effectively. Examples of suitable salts are: guanidine carbonate, guanidine sulfate, biguanide sulfate, biguanide nitrate, guanyl urea sulfate, guanyl urea nitrate, guanyl urea carbonate, etc.

The anion active resins may be prepared in the same general manner as that described in U.S. Pat. No. 2,251,234 or U.S. Pat. No. 2,285,750. Most preferably, the starting anion exchange material is a strong base, styrenic polymer, gel-type resin.

Any anion exchange material will remove, for example, silicate anions from a contaminated water source. However, commercially available anion exchange materials, including the anion exchange resins described above, allow the silicate to be displaced from the anion exchange materials by other ions present in the water source, most notably sulfate, chlorides, carbonates and bicarbonates, such that the anion exchange materials are capable of only a very limited throughput before it becomes overrun causing it to “dump” the silicate. Dump is a chromatographic term used in the art describing the mechanism by which an ion of higher preference displaces an ion of lower preference which then comes out of the resin at concentrations higher than the inlet concentration. In contrast, the modified anion exchange materials of the present invention do not dump silicate in typical potable water chemical environments.

The term “cation exchange material” means cation exchange materials, such as resins, granules, beads, and grains. These can be gel types or macroporous types, most preferably, gel types having at least one metal wherein at least a portion of the metal is inside the materials as taught herein. The cation exchange material with which one starts, may be any particular water-insoluble polymeric material which contains strongly acidic or weakly acidic groups such as sulfonic, phenolic, carboxylic, EDTA, groups attached to the polymeric material including those described in more detail below. Such cation exchange materials are known to those of ordinary skill in the art and selection of a particular cation exchange material or structure is considered within the skill of those knowledgeable in this field. However, it is understood, and has been observed, that cation forms of the modified exchange materials described herein are capable of removing less of the ionic forms of silica compared to anion forms of the modified exchange materials described herein.

As used herein, “complexing group” or simply “complex” means an atom, molecule, ion or chemical group which, upon being bonded, attached, sorbed or physically located at, close to or throughout the volume of a solid surface or a porous structure or support, the material causes a significant enhancement in the tendency of an ionic or neutral species to adhere to its surface or to become attached or occluded inside the porous solid.

Specifically, the ion exchange materials described in the present invention are directed to compositions of matter having at least one metal wherein at least a portion of the metal is inside the materials being used to remove silica from a source. Preferably, the metal is located throughout the ion exchange materials. For example, the ion exchange materials described herein can be strongly basic anion, weakly basic anion, strongly acidic cation or weakly acidic cation exchange materials impregnated with a metal containing substance.

It is not well understood by those of ordinary skill in the art how one overcomes the cationic charge barrier, often referred to as the Donnan barrier, present inside an ion exchange material such that cations are able to penetrate the surface of the anion exchange material. Thus, the present invention also relates, in part, to anion exchange materials which are very selective such that certain anions that contain silica are transferred or exchanged past the Donnan barrier and into the anion exchange material. Accordingly, a surprising and unexpected benefit of the process of the present invention is that a metal is contained or trapped in the exchange material in a solid state but is still able to take part as though it were finely dispersed within the exchange material. Meanwhile, the anion exchange material continues to function in a manner similar or the same as it was capable of functioning prior to containing the metal. In other words, the anion exchange material with the metal inside the material, as described in more detail below, acts as both its original anion exchange material and as a highly selective adsorbent for silica. Likewise, a cation exchange material with a metal inside the material will still function as an ion exchanger with all its former preferences and affinities intact except that it is also capable of removing silica from a source.

A series of exhaustion experiments were performed using water having the following properties:
conductivity 895 micromhos;
pH 8.6 (reduced to 6.1 by addition of HCl when lower pH is noted);
211 ppm total hardness;
98 ppm alkalinity (as HCO₃); and
22 ppm silica (as SiO₂).

As stated, FIG. 3 shows the relative capacity of ResinTech SBG1 resin in the chloride form (SBG1-Cl) to remove silica. The chloride forms means that the chloride ion is a mobile ion in the resin. As shown in FIG. 3, there is very little silica removal using the SBG1 resin in the chloride form. However, it is possible to prepare an anion exchange material that has a mobile ion that is less preferred than silica. This is demonstrated in FIG. 4 in which borate is the mobile ion. As shown in FIG. 4, the borate form of the SBG1 anion resin is able to remove substantially more silica than the chloride form of the same parent resin.

However, as also shown in FIG. 4, silica dumping occurs if the exchange continues past the depletion point of borate exchange sites. Thus, while FIG. 4 provides interesting results, it is not always very practical or desirable to use the borate (or hydroxide) form of an anion resin as borate ions, like hydroxide ions, are sometimes undesirable in treated water. As a result, silica removal has generally been limited to applications where complete deionization is practiced.

The present invention provides a process for the addition of a metal oxide/hydroxide adsorbent into an ion exchange material which results in a modified or hybrid-type ion exchange material. As a result, the process of the present invention provides a unique ability to remove large quantities of silica, even when an aqueous solution is at or near neutral pH and even when the mobile ion is not less preferred than silica. Such modified ion exchange materials can be prepared from either cation or anion exchange materials, can have either weakly or strongly ionized functional groups, can be gelular or macroporous, and can have almost any mobile ion or combination exchanged to the fixed charges of the exchange materials.

By way of example, a modified cation exchange material described herein was prepared by regenerating a hydrogen form strong acid cation resin (ResinTech CG8) into the ferric iron form by passing an excess of ferric ions (1 molar ferric chloride) in the form of a salt through the resin. Although ferric chloride is know to form anionic complexes that load as ions onto the functional groups of anion resins, ferric chloride also has ferric ions (Fe⁺³) that directly exchange onto the functional group of cation exchange materials. A relatively low concentration favors exchange onto cation exchange materials while higher concentrations generally favor the formation of FeCl₄⁻ complex that exchange onto anion exchange materials. The ferric iron was then precipitated inside the resin by allowing the resin to react with a strong sodium hydroxide solution by soaking in the solution or by contacting the resin with a flowing solution.

It should be appreciated that a high concentration of hydroxide ions is desired during the precipitation step to overcome Donnan exclusion and insure that a significant number of hydroxide ions are able to penetrate the resin and react with the iron. During this step the iron that was exchanged as the mobile charge is replaced with sodium and the iron reacts with the hydroxide ion to form ferric hydroxide which precipitates and remains trapped inside the resin. It should also be appreciated that other iron compounds such as ferric nitrate, ferric acetate, ferric bromide, ferric iodide, ferrous sulfate and similar ferric compounds could also be used to regenerate the cation resin to the ferric ion (Fe⁺³) form. Also, the source of hydroxide ions is not limited to sodium hydroxide, as potassium hydroxide, lithium hydroxide, ammonium hydroxide and similar hydroxide compounds could also be used to precipitate the iron inside the resin. Though not all hydroxides or alkalis are equally efficient on a molecular exchange basis, acceptability of other alkalis will vary depending on such factors as availability and cost.

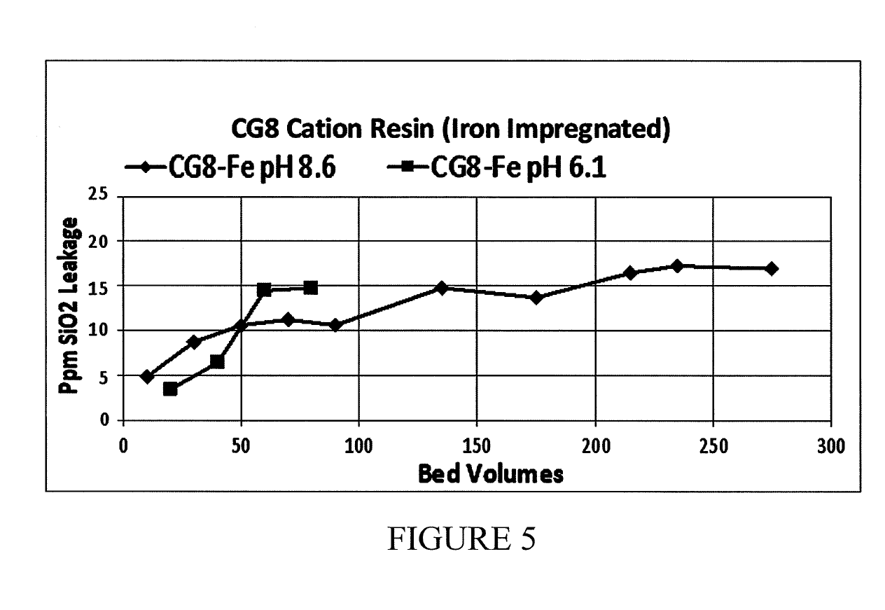

Accordingly, the method of removing or recovering silica from a source can be described as including the steps of: exchanging a metal ion such as ferric iron onto a cation exchange material; immobilizing the metal as a precipitate located throughout the resin by passing a solution containing cations and anions that include a precipitating agent such as a hydroxide to displace the metal from the ion exchange resin functional groups and simultaneously precipitate the metal within the resin; and contacting the source with at least a portion of the metal containing anionic substance. Repeating the process steps prior to the contacting step many times will increase the amount of metal inside the ion exchange material. For example, by passing a solution of ferric salt through a cation exchange resin the passing a solution of sodium hydroxide through the resin results in the resin becoming converted to the sodium form and ferric hydroxide precipitation inside the gel phase of the resin thus creating the cation exchange version of the silica removing resin. FIG. 5 shows results from using the modified cation exchange material made by this method to remove silica from water having the above identified properties. The cation resin in FIG. 5 has about one third as much precipitated iron as the ASM-10 resin yet it still provided excellent silica removal. If fully loaded with iron the cation resin can hold about 50% more precipitated iron then the strong base resin used to make ASM10. Silica removal capacity increases in proportion to the amount of precipitated iron.

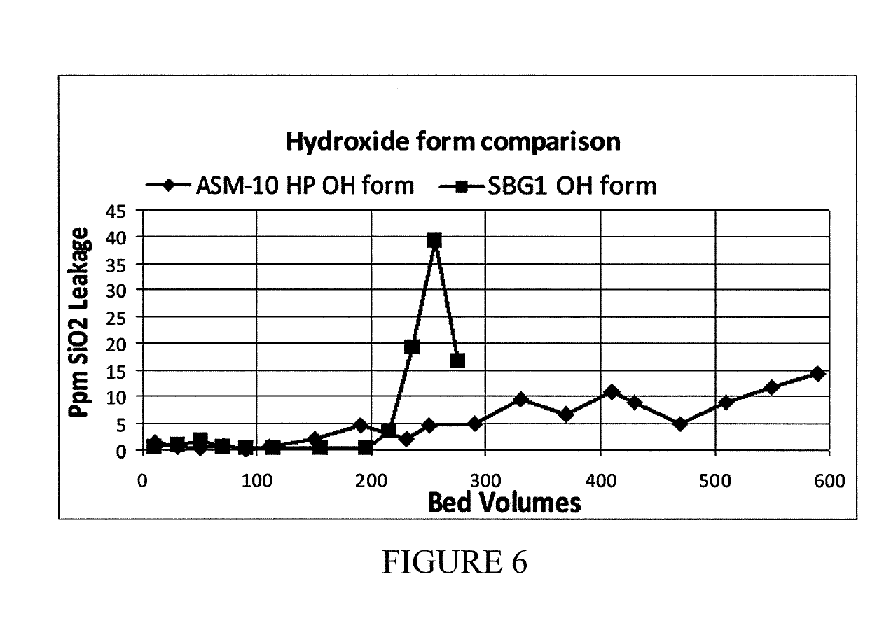

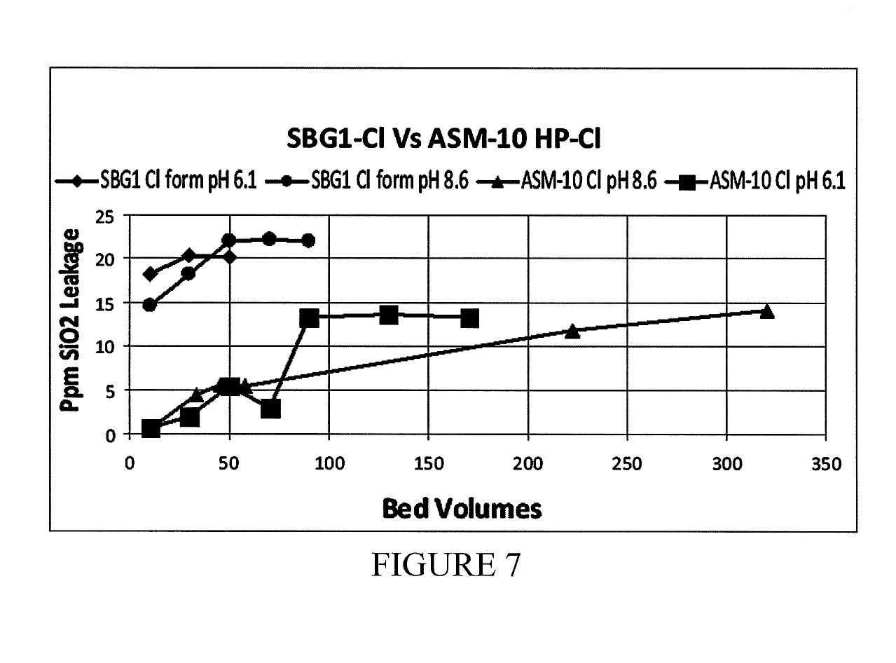

The modified anion exchange materials described herein are described in detail by Gottlieb et al. in U.S. Pat. No. 7,504,036. A similar modified anion exchange material can also be prepared by the method described by Sengupta et al. in U.S. Pat. No. 7,291,578. The basic method or process is similar to that of making the modified cation exchange material described above. Here, the anion resin is first regenerated into the ferric chloride form, and then the iron is precipitated inside the polymer using sodium hydroxide or another strong base. FIGS. 6 and 7 show results from using the modified cation exchange material made by this method to remove silica from water having the above identified properties silica.

Regeneration is carried out by contacting the exhausted modified ion exchange material with a chemical solution (preferably a solution containing hydroxide ions) that removes the silica from the modified exchange material and returns the material to its original state. For example, Fe(OH)₃ reacts with silica to form a ferric silicate salt that remains fixed in resin. An example of this exchange during the exhaustion cycle and the reverse exchange during the regeneration cycle is shown as follows:

Exhaustion: Fe(OH)₃+H₄SiO₄→Fe(OH)₂(H₃SiO₄)+H₂O. Fe(OH)₃ reacts with salts of silicic acid as in the following example:
Fe(OH)₃+H₃SiO₄→Fe(OH)₂(H₃SiO₄)+OH⁻.

### Regeneration: Fe(OH)₂(H₃SiO₄)+Na+OH→Fe(OH)₃+NaH₃SiO₄

and Fe(OH)x(H,_{0,1,,2}SiO_{2,3,4})^{-1,2,3,4}+excess OH⁻→Fe(OH)₃+H₃SiO₄⁻+H₂SiO₄⁻²+HSiO₃⁻³,+SiO₃⁻⁴+OH⁻ (the ratio of the various salts depends on the amount of NaOH used.).
   There are several additional exchanges and regeneration reactions that can occur using all four of the hydrogen components of H₄SiO₄ and three of hydroxide components of Fe(OH)₃.

The precipitated metal has little affinity for most of the few ions found in appreciable concentrations in potable and make-up waters, while most of these ions have varying, and in some cases high, affinities for the parent resin. However, the hydroxide ion has an extremely high affinity for the precipitated metal but very little affinity for the anion parent resin and no affinity for cation parent resin.

The anion exchange based modified exchange material will interact with the negative ion component of the regenerant during the regeneration and will become partly or fully converted to that ionic form. This may or may not be objectionable. In some cases it is desirable to use two or more salts to regenerate the silica from the modified exchange material (both the hybrid material and the parent ion anion exchange material). The use of two or more salts can be accomplished simultaneously by applying a single solution containing the regenerating agent plus the salt or salts to regenerate and or adjust the composition of the parent resin simultaneously. Alternately, regeneration can be carried out in multiple steps with solutions of different chemicals, or regeneration can be carried out in combinations of the above. For example, using a single solution to remove the silica from the resin or the hybrid material, or both, followed by a series of solutions with one or more salts to change the ionic composition of the parent resin. For example, regeneration of an anion modified exchange material, can be performed using a sodium hydroxide solution. This will remove silica, leave the metal in the hydroxide form, and result in the parent exchange material being at least partially in the hydroxide form. The exchange material can then be rinsed with a NaCl solution. The chloride ions will dislodge the hydroxide and other ions from the material and convert the material at least partially to the chloride form depending on the quantity of chloride ions contained in the regenerant. The precipitated metal remains in the hydroxide form as it is unaffected by chloride ions. In this manner and using other salts the parent exchange material can be made into a variety of ionic forms including combinations of various ions such as bicarbonate, carbonate, borate, sulfate, bromide to name just a few.

Satisfactory hydroxide and chloride levels can be achieved with a single mixed salt regeneration containing both NaCl and NaOH or in other cases where other ion mixtures are desired using different salts. For example, the chloride ion has a much greater affinity for an anion resin than the hydroxide ion. The reverse is true of the modified ion exchange material described herein. So, for example, a solution of 2% NaOH and 2% NaCl would regenerate the silica removing capacity and the parent exchange material would remain about 90% in the chloride form.

The same logic discussed in regenerating anion based modified exchange materials can be used with cation based exchange materials where the precipitated metal is inside a cation exchange material. The can be affected by the presence of other ions. For example, cation exchange resins often exchange calcium, zinc, magnesium and iron. These substances precipitate inside and outside the external surface of resin beads when exposed to hydroxide ions and can be exchanged off the resin into contact with the solution by the sodium ion. This can be prevented by regenerating the resin with a NaCl solution first and then with a NaOH solution. The NaCl removed iron, calcium, zinc and any other cations from the resin that would be affected by the hydroxide ions in the NaOH thus avoiding the problem of precipitation and fouling of the resin. The precipitated metal hybrid is stripped of its silica by the NaOH solution.

It is more difficult to regenerate the metal inside a cation parent because of the Donnan Membrane Effect. The number of positive and negative ions must be equal at all times in a system and the ionic concentrations inside and outside the gel phase of the ion exchange resin must also be in balance. Since the ion exchange groups of the cation exchange resins are negatively charged the shift equilibrium concentrations against the presence of other negatively charge ions such as hydroxide inside the gel phase. This limits the amount of hydroxide ions that can enter the resin where the metal hybrid resides and therefore retards the regeneration process, much of this can be overcome by controlling concentration and contact time. As the hydroxide ions inside the resin free the metal of the silica, the silica becomes ionized and is expelled from the resin. This creates an imbalance of hydroxide ions and allows more hydroxide to enter the resin to replace the hydroxide consumed by reaction with and replacement of the silica removed from the precipitated metal.

Regeneration of both the modified anion exchange material and the modified cation exchange material is possible. If a sufficient excess of hydroxide ions are forced into contact with the iron adsorbent, then silica will be displaced and rinsed from the modified exchange materials. In the case of a cation exchange material, such as ResinTech CG8, it may be necessary to first regenerate the material using sodium chloride or another monovalent salt in order to remove divalent cations, such as calcium and magnesium, that would otherwise precipitate during subsequent contact with hydroxide solutions or the amount of precipitate is reduced to a level that will not interfere with the performance of the resin. As previously mentioned, the hydroxide concentration needs to be sufficiently high to cause a large number of the hydroxide ions to penetrate the exchange material. Such reactions are generally quite slow and therefore sufficient contact time is needed to allow hydroxide ions to fully penetrate the exchange material

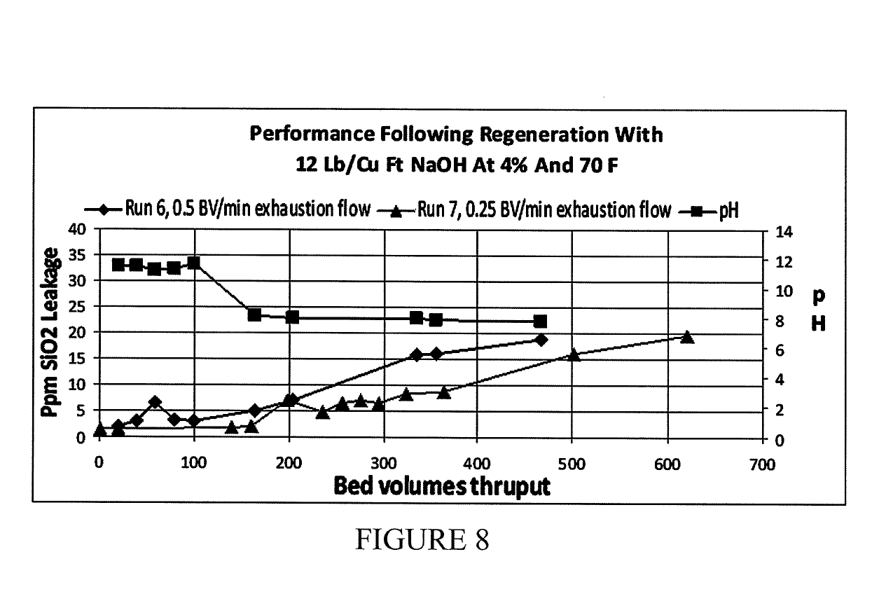

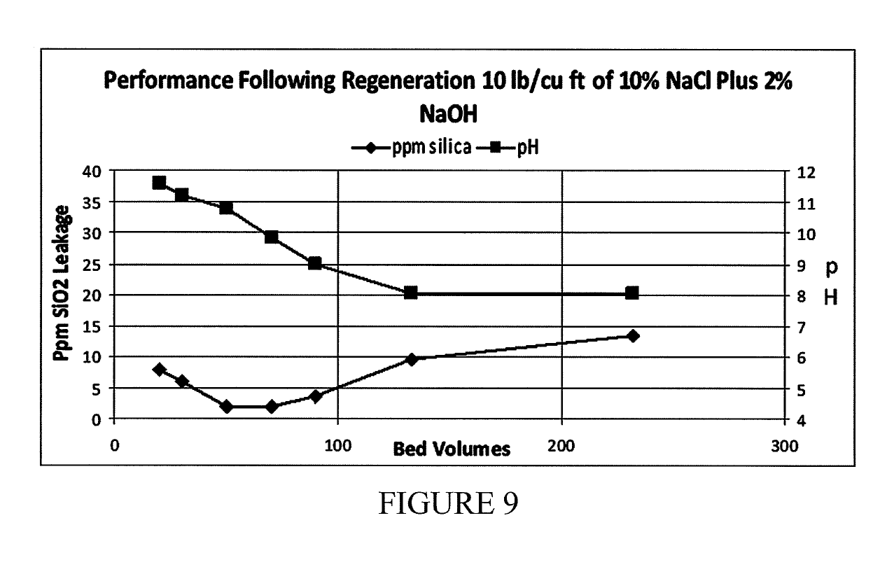

The modified anion exchange material can be regenerated with a solution containing hydroxide ions, such as a sodium hydroxide solution, or with a mixed salt and a hydroxide solution, such as a sodium chloride mixed with sodium hydroxide solution. Although sodium hydroxide is a relatively potent regenerant, the use of brine caustic mixtures results a smaller fraction of an exchange material's mobile ions in the hydroxide form. However, this smaller amount of mobile ions in the hydroxide form is sometimes desired. Following regeneration with caustic, or brine and caustic, the exchange material can be neutralized or left in the alkaline form depending, e.g., on the desired pH in the effluent. FIGS. 8 and 9 show the performance of a modified anion exchange material in removing silica from water made by the process described herein after the material has been regenerated. Though not as widely applicable, weakly basic parent resins with precipitated metal can function with even greater efficiency in certain situations and offer extremely efficient silica removal. Sodium hydroxide can freely enter the gel phase of the resin and react with the exhausted metal silicate without reacting with the weakly basic parent resin. Weak base resins function as acid absorbers rather then by the exchange of ions. Regeneration with NaOH neutralizes any adsorbed acid leaving the resin devoid of ionic charge. The regenerate weakly basic resin is referred to as being in the “free base” form because it has no ions to exchange but is available to adsorb/absorb acid molecules such as HCl, HSO₄, HNO₃. Weakly basic resins perform best at adsorbing strongly ionized acids and have virtually no capacity for silica removal.

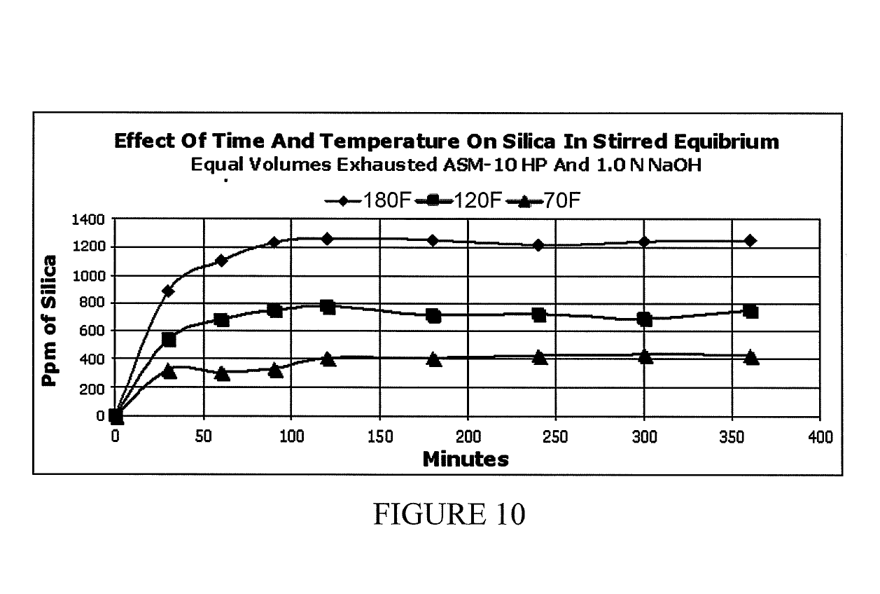

It should be appreciated that silica removal from a modified ion exchange material is very dependent on contact time and temperature. As shown in FIG. 10, increased temperature and increased contact time both improve the removal of silica from spent exchange material.

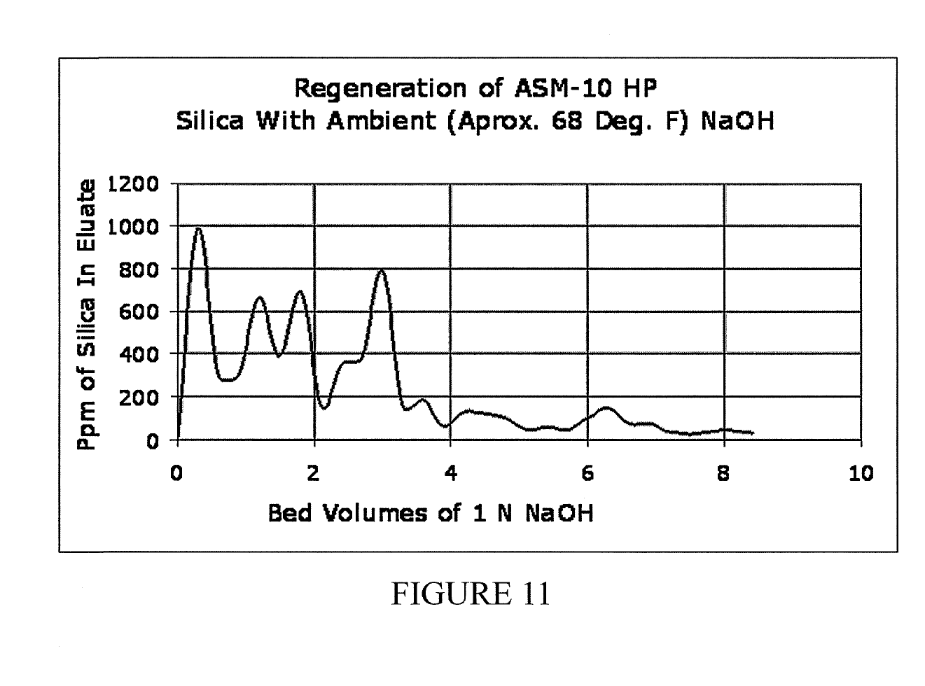

FIG. 11 shows the elution of silica from exhausted ResinTech ASM-10 HP resin during regeneration with 4% NaOH at room temperature. As shown in FIG. 11, the resin was regenerated more quickly and to a greater degree at higher temperature.

The process of the present invention has wide point of use applications including, for example, the treatment of steam generation systems, boiler water systems, nuclear power plant systems, municipal water supplies, plumbing systems, water distributors, cooling towers, etc., as well as point of use applications in other fields, including sanitization and sterilization, such as medical, dental and veterinary disinfection and sterilization, surface and instrument disinfection and sterilization, hot and cold water sanitization, dental water line sanitization, membrane sanitization and sterilization, as well as food and animal disinfection, bacteria control, waste treatment, and ionic purification of aqueous solutions. It will be appreciated by those skilled in the art that other uses of the modified anion exchange materials and modified cation exchange materials of the present invention are possible without departing from the broad invention concept thereof.

As mentioned above, low pressure boilers use blowdown to control the concentration of salts and silica in order to prevent mineral deposits from forming in the boiler and other equipment. Water hardness and silica are two substances that are typically monitored closely in boiler systems and blowdown rates adjusted to control them within specified limits. Draining concentrated salts from the boiler by the blowdown method and replacing the water with fresh make-up water is a preferred method of boiler control. However, the hot blowdown water removed from the boiler system reduces the thermal efficiency of the system. As a result, devices, such as heat recovery exchangers, are used to recover a portion of this heat.

Nuclear power plants often employ borated water systems as neutron moderators to control the rate of heat generated by the nuclear fuel materials. Such systems are adversely affected by the presence of silica, yet it is desirable not to remove borate or to add any other ions to the water. The borate form of the hybrid is ideal for this application. The hybrid exchanger can be used in the hydroxide form and allowed to convert to the borate form while in use or can be used in the borate form initially. Silica is removed preferentially and will not dump no matter how long the resin is left in service. The resulting removal of silica and longer service life results in lower operating costs, less worker exposure and better water chemistry compared to existing methods of treatment.

Cooling towers are often blown down based on limits of silica solubility. Blowdown is a term for the portion of water removed from the cooling system to avoid concentration of salts past their solubility limit. Blowdown is expensive and in many cases is not environmentally acceptable. Removal of silica, without the need to remove other salts as well results in less blowdown and lower operating cost. Such removal need not be complete for the process to have economic value, it is only necessary to remove a fraction of the silica in order to reduce cooling tower blowdown.

Membrane processes such as reverse osmosis and electrodialysis as well as evaporative process such as distillation often are limited in product water recovery by the solubility of silica in the concentrate stream. Even partial removal of silica can result in significantly reduced operating cost thru lower pumping costs, reduced chemical use and a smaller volume of waste water produced.

Water softeners, which typically employ cation exchange resins and are typically operated in the sodium form by regeneration with sodium chloride, are routinely used to remove hardness from boiler feed water. Other forms, such as amines, potassium or other divalent ions, are sometimes used. Silica levels are rarely specifically reduced in boiler systems because silica has been considered too costly to treat for the benefit received by its reduction. However, partial removal of silica can result in significant energy savings providing silica levels in boiler systems can be reduced efficiently.

Silica removal has typically been accomplished by using ordinary strong base ion exchange resins operated in the hydroxide form. However, as mentioned above, this usually uses sodium hydroxide, a relatively expensive substance as the regenerant. However, because the modified ion exchange materials of the present invention have a precipitated metal in the material, the material is capable of reacting with un-ionized silica thereby eliminating the need for an expensive pH raising alkali addition.

The results shown above are the result of experiments run at exhaustion flow rates of 0.5 bed volumes per minute which is about 50% faster then routine or ordinary design flow rates for ion exchange resins. It has been found that higher flow rates create early break through of the resin and gradually increase leakage. However, in most applications, complete silica removal is not necessary. For example, a significant percentage of low pressure boilers that do not now practice silica reduction of boiler feed water would benefit from a moderate reduction of silica in the boiler system.

Also, the mechanism of the reaction between silica and the precipitated metal of the modified ion exchange materials is not as fast as the exchange between an ion exchange functional group of the parent resin and an anion. The silica has to penetrate the gel phase of the exchange material to come into close contact with the precipitated metal by diffusing through the gel phase of the material. The diffusion rate in the gel phase is significantly slower (approximately 10 times) than in the external liquid phase. There is an extra step of reaction and ionization in the removal of non-ionic silica that further slows the exchange rate and makes the process more rate sensitive. This can be overcome by dealing with the parameters that affect the removal step. For example, slower unit volume flow rates and higher temperatures and pH all help the process when anion exchange resins are the parent resin. When a cation resin is used as the parent resin the pH has less of an effect, at least until the pH rises significantly above 9. Higher pH retards the removal of silica because some of the silica becomes ionized and cannot efficiently enter the gel phase of the cation resin to contact the precipitated metal of the modified ion exchange material. Since only the non-ionized silica will be removed by the cation based modified ion exchange material, the increase in pH hinders the removal of silica. This is shown above by comparing the removal of silica for the cation based material at pH 6.1 and 8.4 which is 100% and 96%, respectively, unionized, as expected the removal patterns are similar.

Preliminary tests indicate that the non-ionized silica is removed from water by cation based modified ion exchange materials as well as by anion based modified ion exchange materials. At higher operating pH, the anion material performs better and is less rate sensitive than the cation material because a portion of the silica is ionized and enters the material via the ion exchange sites which provide a faster pathway. From the ion exchange site, the silica is free to quickly move throughout the exchange material and react with the precipitated metal. This frees the silica from the exchange material and allows space for additional exchange.

The ionized portion of the silica is removed quickly as it comes in contact with ion exchange sites of the parent resin that still have available silica capacity. The non-ionic silica is removed at a slower rate and more gradually throughout the resin bed by diffusion into the resin and throughout the gel phase of the resin before becoming held by the precipitated metal. As the operating pH rises, the fraction of ionized silica rises and the overall rate of silica removal also rises. However, the total operating capacity of the modified resin material is primarily due to the silica holding capacity of the precipitated metal. The combination of the metal with the exchange material is synergistic at elevated pH. An example of this occurs when the strong base modified resin material is operated in the hydroxide form on an influent water with an anion concentration of 4 meq/L (200 ppm as CaCO₃). The parent resin releases hydroxide ions in exchange for the ion content of the raw water. As a result, the pH of the water becomes about 12. It is mentioned that the 5 Great Lakes, and the Mississippi and Missouri Rivers have anionic contents in excess of 4 meq/L.

It can be seen from this example that the operating pH during the exhaustion of the parent resin hydroxide cycle will depend solely on the anion concentration in the raw water until all the hydroxide ions are depleted from the exchange material. All the silica becomes ionized and is quickly removed by the parent anion exchange resin. Silica leakage is virtually zero during this stage. As the exchange material's hydroxide ions are depleted, the operating pH drops and so does the rate of silica removal. Continued silica removal after depletion of hydroxide capacity of the exchange material depends on the silica being removed by the precipitated metal.

When the parent resin is an anion exchanger, ionic silica will also penetrate at high pH, the gel phase of the exchange material and reach the precipitated metal by gel phase diffusion and by ion exchange migration through the functional groups of the parent resin. As ionic silica is removed from the source, the remaining silica will re-establish ionic equilibrium by disassociation in accordance with the mass action equilibrium equations shown earlier. At lower pH, this ionic pathway is reduced and the overall silica removal process becomes slower.

Reducing the bed volume flow rate will increase the contact time and compensate for the reduced rate of silica removal. Warming the source will increase the diffusion rate of silica and improve performance. Since blowdown heat recovery is often practiced, this process can take advantage of this heat to warm the influent. Even in cases where heat recovery is not practiced, the resulting increased heat efficiency from the lower blowdown rates made possible by the reduction of silicic in the boiler feed water can be a significant economic benefit to the operation of the boiler.

In high pH waters, a weakly basic parent resin may be the best choice because both ionized and unionized silica can easily enter the gel phase to react with the precipitated metal and lesser amounts of alkali regenerant, such as NaOH, is needed to regenerate the resin. Weakly basic resins are not normally used at high pH (above 7) except for special purpose applications. Even in non-special applications the weakly basic resin allows the metallic complex to function without hindrance on ionized and un-ionized silica. Since the parent resin remains dormant, the alkali (e.g., NaOH) needs to regenerate only the silica laden metal complex.

Regeneration of the cation resin based exchange material of the present invention is more complex when the exchange material is operated both as a softener and for silica removal. Insoluble hydroxides will tend to precipitate when exposed to sodium hydroxide. The cation based exchange material can be used simultaneously to reduce hardness and silica. In this application, the exchange material would be regenerated with a salt to remove accumulated calcium, magnesium and other divalent ions from the parent resin functional groups. Those familiar with the field know that several choices of salts can be used and that NaCl is the salt most often used for this purpose. Also, the exchange material must be regenerated with an alkali to remove the accumulated silica. This can be in combination with the salt in the case of an anion exchange resin parent exchange material or in separate regeneration steps for cation parent materials or as an alternate approach for an anion based hybrid. Typically, but not necessarily, NaOH is used for this step.

Precipitation of divalent ions which are usually insoluble in NaOH and hydroxides in general must be avoided. A method for accomplishing this is to separate the salt and NaOH regeneration steps into sequential steps. Regeneration with NaCl, which is the common regenerant for water softeners, can be first to reduce hardness in the exchange material. The exchange material can then be rinsed and regenerated with a NaOH solution of sufficiently low concentration to avoid precipitation, or keep precipitation at a low enough level to not cause operating difficulties. The maximum NaOH concentration that can be used and still avoid precipitation depends on the composition of the influent water and the degree of regeneration effected by the NaCl step. Also, the flow rates, temperature and use of stabilizing agents can be used to enhance the efficiency and effectiveness of the regeneration step.

A primary purpose of the present invention is to provide an improved process which effectively and efficiently removes silica (both in the ionized and non ionized form as SiO₂, H₄SiO₄, H₃SiO₄⁻¹, H₂SiO₄⁻², HSiO₄⁻³, SiO₄⁻⁴, and to a lesser extent oligametic and polymeric forms of silica) from various sources. In addition to effectively and efficiently reacting with and adsorbing silica, the improved modified ion exchange material described in the present invention can also effectively and efficiently react with or adsorb other metals, including but not limited to, selenium, fluoride, phosphate, silicate, fluoborate, cyanide, cyanate, oxyanions and other similar contaminants from various sources. However, the cation exchange materials of the present invention only fully react with the non-ionized forms of these substances and with reduced effectiveness with the ionic forms.

When these metals are in the form of anions the preferred method is to prepare a modified exchange resin from a strongly basic or weakly basic anion exchange resin. When these metals are in the form of un-ionized substances then the original or parent exchange material can be of either a cationic or anionic exchange material. In some instances it may be desirable to only remove un-ionized forms of the metals when both ionized and un-ionized metal forms are present. In such cases the original or parent exchange material is selected so it will reject the ionized form of the metals. For example, if it is desirable to only remove un-ionized silica, then the parent exchange material would be made from a strong acid cation material such as ResinTech CG8. Because of the Donnan barrier, anionic forms of silica would be rejected whereas the un-ionized forms of silica would enter the material and thereby be removed from the source. Thus, it is an objective of the present invention to provide a method whereby all monomeric and low molecular weight polymeric forms of silica is effectively removed from a source. To accomplish this, the present invention is described primarily as a process which includes the use of modified anion exchange materials.

In addition to silica, the metals or contaminants which are effectively displaced, precipitated or immobilized inside the anion exchange materials referred to above may be, for example, a transition-type metal including, but not necessarily limited to, copper, titanium, zirconium, aluminum, manganese, tin, palladium, platinum, gold, mercury and, preferably, iron. Other metals and their ions, including divalent and trivalent metals, in the same groups of the Periodic Table as those named above are also within the purview of the processes of the present invention. Additionally, there are numerous other reactions which can be effectively used without departing from the scope of the present invention. For example, the publication entitled “Ion Exchange—A Series of Advance,” J. A. Marinsky (Vol. I) at FIGS. 6-8 and 17-18, which are incorporated herein by reference, provides the adsorption characteristics of various metals and, therefore, provides an understanding of the efficiency at which various metals form the modified anion exchange materials of the present invention.

The modified anion exchange materials referred to in the method of the present invention are capable of operating effectively in a wide pH range. For example, the modified anion exchange materials work effectively at a pH range between about 3.0 and about 12.0 and possibly higher, although some decomposition of the modified exchange materials is believed to occur in an environment below pH 3, it is possible that the method of the present invention would be effective at a pH range between 2.0 and 14.0. Preferably the source environment is in the pH range of between 4.0 and 10.0, most preferably between 4.5 to 9.5 since the pH of potable water is usually in the range of approximately 5 to 9. The pH of any source coming into contact with the modified anion exchange materials described in the present invention should be monitored and adjusted, as necessary or desired. At high pH silica becomes a multivalent ion with enhanced selectivity for ordinary ion strongly basic anion exchange materials conversely the hydroxide ion which must be present by definition at high pH competes with silica for the metallic complex causing a reduction in its effectiveness. The combination of the metallic complex in a strong base resin insures silica removal at all pH.

1.-7. (canceled)

8. A method of removing or recovering silica from a source, the method comprising the steps of:
(a) exchanging a metal-containing cation onto a cation exchange material;
(b) immobilizing the metal as a precipitate throughout the exchange material; and
(c) contacting the source with at least a portion of the metal containing exchange material.

9. The method of claim 8, wherein the immobilizing step comprises contacting the exchange material with at least one ionic solution having a precipitating agent to displace and precipitate the metal from the exchange material.

10. The method of claim 8, wherein the immobilizing step comprises contacting the exchange material with a ferric salt solution and then a sodium hydroxide solution.

11. The method of claim 8, wherein the precipitating agent is a hydroxide ion.

12.-18. (canceled)

19. A method of simultaneously softening and removing silica from water in a single ion exchanger, the method comprising the steps of:
(a) providing a cation exchange material in the form of a weakly acidic resin or a strongly acidic resin;
(b) immobilizing a metal as a precipitate throughout the exchange material to form a metal-containing exchange material; and
(c) contacting the water with at least a portion of the metal-containing exchange material.

20-23. (canceled)

24. The method of claim 19, wherein the resin is in a hydrogen form or any salt form.
